(19) United States
(12) Patent Application Publication
(10) Pub. No.: US 2022/0261633 A1
(43) Pub. Date: Aug. 18, 2022

(54) TRAINING A MACHINE LEARNING MODEL USING INCREMENTAL LEARNING WITHOUT FORGETTING

(71) Applicant: Actimize Ltd., Ra'anana (IL)

(72) Inventors: Danny BUTVINIK, Haifa (IL); Yoav Avneon, Ness-Ziyona (IL)

(73) Assignee: Actimize Ltd., Ra'anana (IL)

(21) Appl. No.: 17/494,176

(22) Filed: Oct. 5, 2021

Related U.S. Application Data
(60) Provisional application No. 63/149,516, filed on Feb. 15, 2021.

(51) Int. Cl. G06N 3/08

(52) U.S. Cl. CPC G06N 3/08

(57) ABSTRACT

A device, system, and method for training a machine learning model using incremental learning without forgetting. A sequence of training tasks may be respectively associated with training samples and corresponding labels. A subset of shared model parameters common to the training tasks and a subset of task-specific model parameters not common to the training tasks may be generated. The machine learning model may be trained in each of a plurality of sequential task training iteration by generating the task-specific parameters for the current training iteration by applying a propagator to the training samples associated with the current training task and constraining the training of the model for the current training task by the training samples associated with a previous training task in a previous training iteration, and classifying the samples for the current training task based on the current and previous training task samples.

### CROSS-REFERENCE TO RELATED APPLICATIONS

This application claims the benefit of U.S. Provisional Application Ser. No. 63/149,516, filed Feb. 15, 2021, which is hereby incorporated by reference in its entirety.

### FIELD OF THE INVENTION

Embodiments of the invention are related to the field of artificial intelligence (AI) by machine learning. In particular, embodiments of the invention are related to deep learning using neural networks.

### BACKGROUND OF THE INVENTION

Catastrophic forgetting is a problem in which neural networks lose the information of a first task after subsequently training a second task. The ability to learn tasks in a sequential fashion is important to the development of artificial intelligence. Neural networks are not, in general, capable of this and it has been widely thought that catastrophic forgetting is an inevitable limitation. Catastrophic forgetting is a recurring challenge to developing versatile deep learning models.

In the recent years, online incremental learning (OIL) has attracted a great deal of attention in the deep learning community. Though it is well-known that deep neural networks (DNNs) have achieved state-of-the-art performances in many machine learning (ML) tasks, they suffer from catastrophic forgetting which makes it difficult for continual learning. The problem is that when a neural network is used to learn a sequence of tasks, the learning of the later tasks may degrade the performance of the models learned for the earlier tasks. Our human brains, however, seem to have this remarkable ability to learn a large number of different tasks without any of them negatively interfering with each other. OIL algorithms try to achieve this same ability for neural networks and to solve the catastrophic forgetting problem. Thus, in essence, continual learning performs incremental learning of new tasks.

Conventional OIL techniques not only train on a new task's data, but also retrain on old tasks data. As tasks accumulate, however, their associated training data also accumulates, resulting in prohibitively large amount of training data and prohibitively time-consuming training sessions that train based on all past and current training data.

Accordingly, there is therefore a need in the art to overcome this limitation and efficiently train neural networks to maintain expertise on tasks which they have not experienced for a long time.

### SUMMARY OF EMBODIMENTS OF THE INVENTION

Embodiments of the invention train a machine learning model using incremental learning without forgetting. Whereas conventionally incremental learning unlearns old trained tasks upon learning new trained tasks, embodiments of the invention incrementally train new tasks using training data from old tasks to retain their knowledge. Instead of a naïve approach of retraining by accumulating all training data for new and old tasks which is often prohibitively data-heavy and time-consuming, embodiments of the invention provide an efficient technique to retain prior knowledge.

According to an embodiment of the invention, prior task training data may be efficiently input as a distribution of aggregated prior task training data. For example, prior task training data may be aggregated as a distribution profile defined by a mean, standard deviation and mode (e.g., three data points) or more complex (e.g., multi-node or arbitrarily shaped) distributions. Incorporating a distribution of prior task training data provides efficient incremental learning without forgetting by using a compact data representation of the prior task training data to reduce memory consumption, as compared to simply inputting the prior task training data itself (e.g., using three aggregate data points instead of hundreds or thousands of past training samples). Using such a compact data representation of the prior task training data distribution further increases training speed as training is based on less data, compared to inputting the raw prior task training data itself. Additionally, training using a distribution of prior task training data prevents over-fitting by providing an averaged accumulation of knowledge instead of specific knowledge based on the actual past training samples. This leads to retention of a general impression of past knowledge, without fixing the model to the exact past knowledge that often results in an inflexibility to train future tasks.

According to an embodiment of the invention, prior task training data may be input, not as additional training data, but used to modify a propagator, which is then applied to current task training data to generate model parameters. This allows the prior task training data to be embedded into the model without actively training on the data and therefore without requiring training labels. Incorporating the prior task training data without its training labels allows the prior task training data to be input based on its distribution which typically has no labels (labels are linked to specific training samples, not their distributed aggregates) and may also be more accurate than prior task training data by eliminating errors associated with its improper labelling (as labels are generated by the model as it is being trained, before it reaches full accuracy).

Some embodiments of the invention provide a device, system and method for training a machine learning model using incremental learning without forgetting. A sequence of a plurality of training tasks may be received, wherein each training task is associated with one or more training samples and corresponding labels respectively associated with the one or more training samples. A subset of shared model parameters that are common to the plurality of training tasks and a subset of task-specific model parameters for each training task that are not common to the plurality of training tasks may be generated. The machine learning model may be trained in a sequence of a plurality of sequential training iterations respectively associated with the sequence of a plurality of training tasks. In each of the plurality of sequential training iterations the machine learning model is trained by generating the task-specific parameters for the current training iteration by applying a propagator to the one or more training samples associated with the current training task, wherein the training of the model for the current training task is constrained by one or more of the training samples associated with a previous training task in a previous training iteration, and classifying the one or more samples associated with the current training task based on the machine learning model defined by combining the subset of shared parameters and the task-specific parameters generated based on the training samples associated with the current training task and the previous training task.

### BRIEF DESCRIPTION OF THE DRAWINGS

Non-limiting examples of embodiments of the disclosure are described below with reference to figures attached hereto. Dimensions of features shown in the figures are chosen for convenience and clarity of presentation and are not necessarily shown to scale. The subject matter regarded as the invention is particularly pointed out and distinctly claimed in the concluding portion of the specification. The invention, however, both as to organization and method of operation, together with objects, features and advantages thereof, can be understood by reference to the following detailed description when read with the accompanied drawings. Embodiments are illustrated without limitation in the figures, in which like reference numerals indicate corresponding, analogous or similar elements, and in which:

FIG. 1 is a schematic illustration of incremental machine learning causing catastrophic forgetting and solving the catastrophic forgetting problem;

FIG. 2 is a schematic illustration of data structures for training a machine learning model using incremental learning without forgetting, according to some embodiments of the invention;

FIG. 3 is a schematic illustration of data structures for training a data generator, e.g., of FIG. 2, using incremental learning without forgetting, according to some embodiments of the invention;

FIG. 4 is a schematic illustration of data structures for an example implementation of training using incremental learning without forgetting, according to some embodiments of the invention;

FIGS. 5 and 6 are flowcharts of respective phases of detecting events using a machine learning model trained by incremental learning without forgetting, according to some embodiments of the invention;

FIGS. 7-9 are tables of data fetched and integrated into a machine learning model from a telephone channel (FIG. 7), a Web channel (FIG. 8), and an offline channel (FIG. 9), according to some embodiments of the invention;

FIG. 10 is a schematic illustration of a system for training a machine learning model using incremental learning without forgetting, according to some embodiments of the invention; and

FIG. 11 is a flowchart of a method for training a machine learning model using incremental learning without forgetting, according to some embodiments of the invention.

It will be appreciated that for simplicity and clarity of illustration, elements shown in the figures have not necessarily been drawn accurately or to scale. For example, the dimensions of some of the elements can be exaggerated relative to other elements for clarity, or several physical components can be included in one functional block or element.

### DETAILED DESCRIPTION OF THE INVENTION

Embodiments of the invention relate to online incremental machine learning in which data becomes available in a sequential order and is used to update the best predictor for future data at each step, as opposed to a classical machine learning approaches that use a batch learning techniques. For example, embodiments of the invention relate to techniques that make use of various types of streaming algorithms to perform sequential or incremental learning on real-time streaming data.

Online incremental learning is a method in online machine learning in which input data is continuously used to extend the existing model's knowledge, i.e., to further train the model. Online incremental learning represents a dynamic technique of supervised and/or unsupervised learning that can applied when training data becomes available gradually over time. Incremental algorithms may be applied to data streams, also addressing the issues of memory and complexity.

When training on new tasks or categories, a neural network tends to forget the information learned in the previous trained tasks. This usually means a new task will likely override the weights that have been learned in the past, and thus degrade the model performance for the past tasks. Without fixing this problem, a single neural network may be unable to adapt itself to an online incremental scenario, because it forgets the existing information/knowledge when it learns new knowledge. On the one hand, if a model is too stable, it will not be able to consume new information from the future training data. On the other hand, if a model is too flexible it may suffer from large weight changes and forget previously learned representations.

Catastrophic forgetting occurs in deep neural networks (DNNs). One example of catastrophic forgetting is transfer learning using a deep neural network. In a typical transfer learning setting, where the source domain has plenty of labeled data and the target domain has little labeled data, fine-tuning is widely used in DNNs to adapt the model for the source domain to the target domain. Before fine-tuning, the source domain labeled data is used to pre-train the neural network. Then the output layers of this neural network are retrained given the target domain data. Backpropagation-based finetuning is applied to adapt the source model to the target domain. However, such an approach suffers from catastrophic forgetting because the adaptation to the target domain usually disrupts the weights learned for the source domain, resulting in inferior inference in the source domain.

Embodiments of the invention solve the problem of catastrophic forgetting by implementing an accurate and efficient device, system, and method for training a machine learning model using incremental learning of a plurality of tasks that reduces or minimizes forgetting previous task training. Embodiments of the invention may receive or generate an ordered sequence of the plurality of training tasks and may incrementally train the model with each task sequentially in order (not in parallel). Each training task may be associated with one or more training samples and one or more corresponding labels respectively associated with the one or more training samples. To increase training efficiency, the model parameters may be divided into a subset of shared model parameters (common to the plurality of training tasks) and a subset of task-specific model parameters specific to each training task (not common to the plurality of training tasks). The subset of shared model parameters may be directly known, while the task-specific model parameters may be generated by applying a propagator to each training sample. While the subset of shared model parameters are trained for every task, the subset of task-specific model parameters are only trained for their specific associated training task (and not other task with which they are not specifically associated). Embodiments of the invention may thereby eliminate computations for the remaining task-specific parameters not specific to the current task (specific to different tasks), and significantly reducing the associated number of computed parameters and thereby working memory usage and processing power used to conventionally compute those different task-specific parameters. In one example, a model may have 50% shared parameters and 50% task-specific parameters, where the task specific parameters are divided equally among five different tasks (10% task-specific parameters per task). Accordingly, instead of computing all 100% of parameters to train each task, embodiments of the invention need only compute 60% of parameters when training each task (50% shared parameters+10% task-specific parameters specific to the current task), resulting in a 40% reduction in computing time and working memory for training the model.

To reduce forgetting, to train the task-specific parameters for each current task in each current iteration of the plurality of sequential training iterations, in addition the using current training samples associated with the current training task, embodiments of the invention use replay training samples associated with previous training task(s) in previous training iteration(s). Re-introducing knowledge from replay training samples for previous tasks, maintains past training knowledge (reduces past training forgetting) after training subsequent tasks. However, instead of (or in addition to) inputting the replay training samples in the training dataset for the current task (e.g., adding it to the current training sample dataset), the replay training samples may be used to constrain the training for the current task. For example, the current training samples may train an encoder which generates new samples that are introduced as replay samples in the next training iteration, which uses these samples to modify parameters (alter the propagator). This constraint may be, for example, to use the replay training samples associated with one or more previous training tasks to reduce or minimize variations of one or more layer outputs of the model caused by changes in the subset of shared parameters and a propagator resulting from the current training iteration (e.g., as shown in equations 8 and 9). The task-specific parameters for the current training iteration may be generated based on a compressed encoding of training samples associated with the current training task and a non-compressed version of replay training samples associated with previous training tasks. the compressed encoding may be generated by an encoder trained by adding a mean square error reconstruction loss of the one or more training samples associated with the previous training task to a penalized form of a Wasserstein distance between a distribution of the compressed encoding and a multivariate normal distribution of an embedded low dimensional space (e.g., as shown in equations 1 and 2). Using replay samples to constrain the model, instead of simply inputting them into the training dataset, allows the replay samples to be used without labels (training data requires labels). Because labels are generated based on the model, and early model training has poor accuracy, early task iteration samples often have inaccurate labelling. Eliminating labels in the replay samples thus reduces inaccurate training based on those inaccurate labels to increase training accuracy compared to simply adding the replay samples and their labels to the training dataset. In addition, because the replay samples are used without labels, embodiments of the invention may use an aggregated distribution of replay samples zₘ (e.g., averages, standard deviations, modes, histograms, etc.), with which no labels are associated, rather than the discrete samples themselves. Training based on an aggregated distribution of replay samples, rather than the discrete replay samples themselves, provides a more distributed general knowledge of past training, without fixing the model to the exact past knowledge that often results in inflexible over-fitting that is less adaptable to training future tasks. The result of training based on replay sample distributions, as compared to discrete replay samples, is better knowledge retention of past tasks (averaged over many or all past samples) and better training for future tasks (more flexible training). In addition, training based on the aggregated distributions is more efficient because the replay sample data size is bounded by a threshold limit (e.g., three distribution values such as mean, standard deviation, and mode) regardless of how many accumulated replay samples are aggregated (e.g., hundreds or thousands), which cumulatively grows as the number of tasks are incrementally trained. In addition, because past samples are incorporated based on their aggregate distribution, there is no need to store the actual samples for previous tasks, thus decreasing memory usage.

Once trained, the model may classify the one or more samples associated with the current training task based on the machine learning model. This classification may be defined by combining the subset of shared parameters and the task-specific parameters for the current task. As discussed, the task-specific parameters for the current task are generated based on the current training samples associated with the current training task (input as the training dataset) and the replay training samples associated with previous training tasks (to constrain the model).

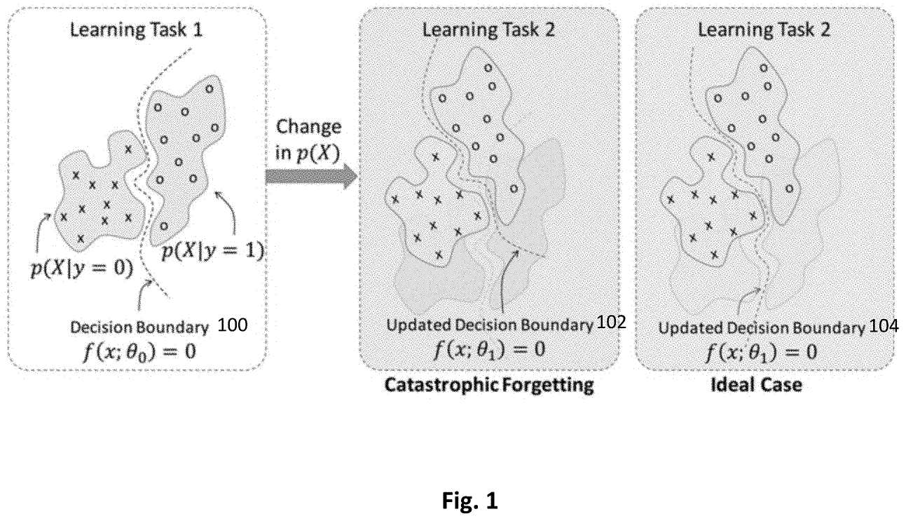

Reference is made to FIG. 1, which schematically illustrates incremental machine learning causing a machine learning model to experience catastrophic forgetting. The model is characterized by parameters p that change upon training each new task i. The model is sequentially trained for each task i using data X and associated labels y to form a decision boundary f(x;θᵢ₋₁), where θ represents, e.g., parameters or weights of the neural network of FIG. 1. The decision boundaries may be applied to data to yield a decision. When training incrementally, after the first task i=1 is trained to generate an initial decision boundary 100, training a subsequent second task 1=2 changes the decision boundary 102 causing the model to forget the initial task training (e.g., data that previously fell on one side of the decision boundary is updated to fall on a different side of the decision boundary). Thus, the model can drastically lose its accuracy to predict on an initial task after being trained on a new task. This usually means a new task will likely override many of the weights that have been learned in the past, and thus degrade the model performance for the past tasks. Without fixing this problem, a single neural network may not be able to adapt itself to a continuous learning scenario, because it forgets the existing information/knowledge when it learns new knowledge.

For some deep learning applications (e.g., disease tracking, fraud detection, etc.), where online incremental learning can be crucial, catastrophic forgetting should be avoided.

In conventional artificial neural networks, all neurons in the hidden layer are initially activated, and in order to concentrate on a specific task, some of them may be turned off. In other words, it may be useful to ‘forget’ all unnecessary information. In the context of artificial neural networks, activation means that the neurons are involved in forward propagation during evaluation and backward propagation during training.

Given a sequence of supervised learning tasks T=(T₁, T₂, . . . T_{N}), embodiments of the invention sequentially train those tasks in the given sequence such that the learning of each new task will not forget the models learned for the previous tasks. Embodiments of the invention thus solve the problem of catastrophic forgetting by providing a decision boundary 104 for each sequentially learned new task Tᵢ that retains knowledge of all past tasks T₁, . . . , Tᵢ₋₁.

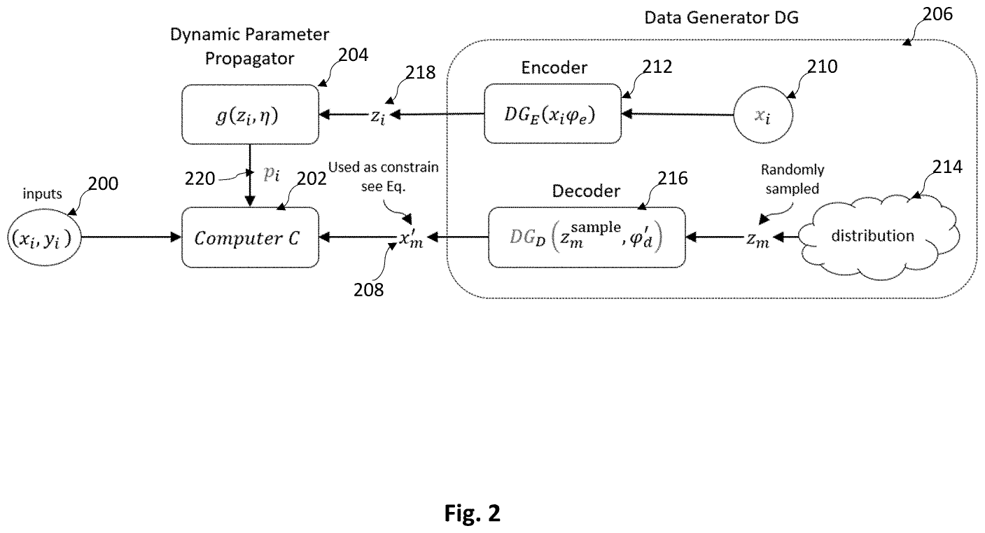

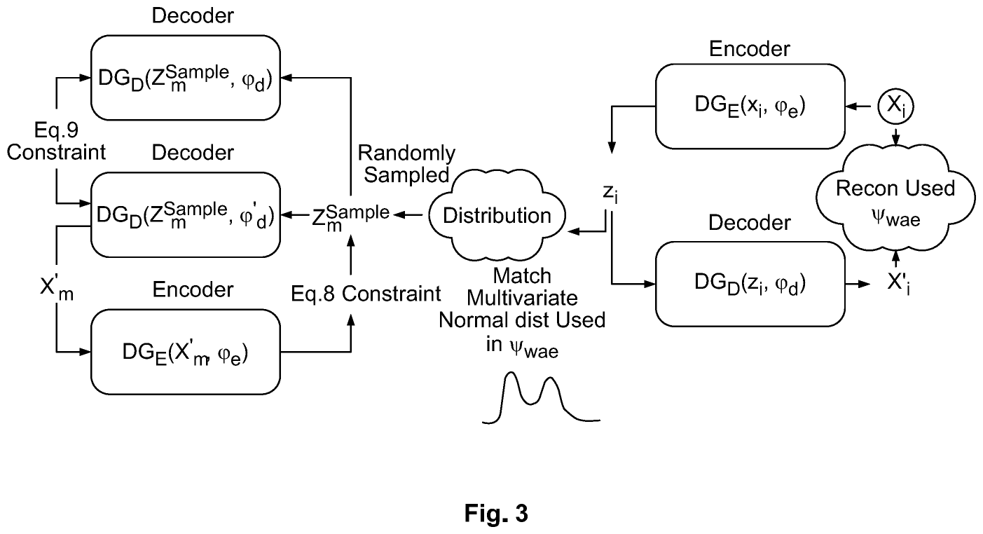

Reference is made to FIG. 2, which schematically illustrates data structures for training a machine learning model using incremental learning without forgetting, according to some embodiments of the invention. FIG. 2 illustrates a novel approach, called Parameter Propagation and Learning Adaptation (PPLA), to solve the catastrophic forgetting problem and to significantly reduce accuracy deterioration. PPLA does not learn a joint parameter set φ*. Instead, it learns a parameter propagator g(·) and a shared parameter set φ₀. In PPLA, the overall classification network, referred to as the computer C 202, has two disjoint subsets/parts of parameters. The first subset is shared parameters φ₀ common all tasks learned so far. The second subset is a place holder H that will be filled by parameters generated by propagator g(·) 204 for each test instance 200. That is, given a test instance 200, a set of parameters pᵢ 220 will be generated by the learned parameter propagator g(·) 204 to replace H. Computer C 202 then combines shared parameters φ₀ and the generated parameters for the test instance 200 to classify it. Embodiments of the invention do not have a network with a set of fixed parameters for computer C 202. The shared parameters φ₀ contain the common features of all tasks, and the generated parameters 220 for each test instance 200 adapt a classification network S for each test instance in order to classify the test instance. Since propagator g(·) 204 and the shared parameters φ₀ will change during training for each new task, forgetting can occur for previous tasks. To solve this problem, in training propagator g(·) 204 and classification network S for each task Tᵢ, in addition to the training data of Tᵢ, a small number of replayed samples may be generated by a data generation network (e.g., shown in FIG. 3) for the previous tasks T₁, . . . , Tᵢ₋₁ to ensure that the knowledge learned for the previous tasks remains stable/unforgotten. Compared with existing generative replay methods, embodiments of the invention do not need labels for the replayed data because the replayed data may be used only to constrain the training of computer C 202 and propagator 204 g(·) rather than to treat them as surrogates of labeled training data from previous tasks. Further, since in the existing replay methods, the labels are produced by the existing learned network itself, the labels can be noisy and biased, which may result in errors being accumulated and propagated to subsequent tasks. By eliminating labels in replay data, embodiments of the invention solve this problem.

The sequence of supervised learning tasks may be denoted T=(T₁, T₂, . . . T_{N}). Each task Tᵢ is represented by Tᵢ={xᵢⱼ, yᵢⱼ|j ϵ (1, . . . , Nᵢ)}, where xᵢⱼ is the j-th example/sample of Tᵢ, and yᵢⱼ is its associated label. (x^{t}, y^{t}) denotes a test instance/example 200. To simplify the notation, (xᵢ, yᵢ) denotes a training example from task Tᵢ, omitting the second subscript j. The terms example, sample, and instance may be used interchangeably.

The proposed parameter generation and learning adaptation (PPLA) architecture may include computer C 202, propagator g(·) 204, and data generator DG 206:

Computer C 202 is a classification model. The parameter set of computer C 202 may include two subsets, φ₀ that is shared by all tasks (and instances) and H, a parameter place holder, which may be replaced by the generated parameters set pᵢ (or p^{t}) 220 for each training (or testing) example xᵢ (or x^{t}) 200. Parameters set pᵢ (or p^{t}) 220 serves to adapt the computer C 202 to classify the example 200 in training or testing. Embodiments of the invention adopt this parameter split because only part of the parameters of a neural network may be adjusted when learning a new task.

Dynamic Parameter Propagator (DPP) g(·) 204 takes the embedding zᵢ (or z^{t}) 218 of each input training (or testing) example xᵢ (or x^{t}) 200 to generate the parameters pᵢ (or p^{t}) 220 for computer C 202. Embedded data zᵢ (or z^{t}) 218 may be used instead of raw data xᵢ (or x^{t}) 200 to reduce the raw data's dimension. The embedding zᵢ (or z^{t}) 218 as a relatively low dimensional dense representation, as compared to raw data 200, reduces the mapping space for DPP 204 and thus reduces the difficulty in its parameter generation.

Data Generator (DG) 206 may generate a set of replayed data or samples {x′ₘ}ₘ₌₁^{M} 208 using its decoder DG_{D} 216 for previous tasks to deal with catastrophic forgetting. Additionally or alternatively, data Generator (DG) 206 may generate the embedding zᵢ (or z^{t}) 218 of each input training (or testing) example xᵢ (or x^{t}) 210 using its encoder DG_{E} 212.

### Overall Approach of PPLA

Testing is described first before training. Given a test instance x^{t} 210, encoder DG_{E} 212 first generates its embedding z^{t} 218, which is fed to propagator g(·) 204 to generate a set of parameters p^{t} 220. Computer C 202 then takes x^{t} 200 as input and uses the trained/learned shared parameters φ₀ and p^{t} to classify x^{t}. Shared parameters φ₀ contains the common features of all tasks learned so far. Parameter set p^{t} 220 adapts computer C 202 for test instance x^{t} 210 in order to classify x^{t}.

For training, the pipeline of the proposed PPLA framework is shown in FIG. 1. Given a new task Tᵢ with its data (xᵢ, yᵢ) 200, computer C 202 and DPP g(·) 204 are jointly trained to learn task Tᵢ and also not to forget the previously learned tasks T₁, . . . , Tᵢ₋₁. In each iteration, a set of parameters pᵢ 220 is generated by the current DPP g(zᵢ, η) 204 for each training instance xᵢ 210 (zᵢ 218 being its embedding), where η is the set of parameters of the DPP network, which is trained.

In training the computer C 202 and DPP 204 for the new task Tᵢ, both g(·) 204 and the shared parameters φ₀ will change, which can cause forgetting in DPP for previous tasks. To keep DPP 204 remembering the acquired knowledge for previous tasks, embodiments of the invention may minimize the variation of certain layers' output caused by the changes of φ₀ and g(·) 204 using the set of replayed samples {x′ₘ}ₘ₌₁^{M} 208 generated by DG 206.

PPLA has training components:

DPP 204 and computer C 202 (referred to as DPP-C). E.g., DPP 204 may be optimized together with computer C 202.

DG 206: The training components have their respective objective functions, and are trained alternately. This is because DPP 204 takes input zᵢ 218 (which is produced by DG 206) to generate parameters 220, and alternating training ensures consistent convergence rates of DG 206 and DPP 204.

Dynamic Parameter Propagator (DPP) 204 and Computer C 202 Implementation: Several neural networks can be used to implement DPP for parameter generation, e.g., convolutional neural network (CNN), recurrent neural network (RNN) and multilayer perceptron (MLP). Although an embodiment is described using MLP, this is a non-limiting example, and any other type of NN can be used. Formally, DPP can be written e.g., as:

pᵢ=g(zᵢ, η)=f(a_{D}zᵢ+b) (eq.1)

where f is an activation function, and a_{D} and b are parameters of DPP denoted by η.

For the implementation of computer C 202, several deep learning networks can be used as well. Each layer of the NN (e.g., MLP) is a perceptron and can be formalized by output=f*(a*xᵢₙₚᵤₜ), where xᵢₙₚᵤₜ denotes the input of the particular perceptron. A perceptron may also be referred to by a basic unit e.g., 1. In general, for each basic unit k of the computer C 202, embodiments of the invention may have a shared portion of the parameters φ_{0,k} and a generated portion of the parameters p_{i,k}, e.g.:

φᵢ^{*}=join(φ₀,pᵢ)={[a_{i,k}^{*}]}ₖ₌₁^{K}={φ_{0,k};p_{i,k}}ₖ₌₁^{K} (eq. 2)

where join (φ₀,pᵢ) is a concatenation of φ₀ and pᵢ, and k may be the number of basic units of the computer C 202. In one embodiment, k may be the number of hidden layers (basic units) of the computer MLP.

The joint method has sufficient capacity to adjust computer C 202 in general because only part of the parameters are generated. p_{i,k} can affect all dimensions of the output of its corresponding basic unit k, e.g., as:

a_{i,k}^{*}xᵢₙₚᵤₜ=φ_{0,k}xᵢₙₚᵤₜ₁+p_{i,k}xᵢₙₚᵤₜ₂ (eq. 3)

where xᵢₙₚᵤₜ₁ and xᵢₙₚᵤₜ₂ are block vectors of x_{input·}p_{i,k}xᵢₙₚᵤₜ₂ may be biased and can adapt the output vector to any point in vector space.

To train DPP-C, embodiments of the invention may use cross entropy loss ψ_{ce}. The objective function of computer C including DPP g(zᵢ,η) and φ₀ for learning each new classification task Tᵢ may be defined e.g., as:

minimize(n, φ₀) {ψ_{ce}(C(xᵢ,φᵢ^{*}),yᵢ)} (eq. 4)

where ψ_{ce} cross entropy, φᵢ^{*} is the whole set of parameters of C (φᵢ^{*}=joint(pᵢ, φ₀)) representing the adaptation of computer C.

The generated replayed samples x′ₘ may be used as constraints to reduce DPP-C's forgetting. That is, to keep the past learned knowledge, the output of the basic units in computer C may not change much when learning a new task with the help of generated data. If no activation function is used, eq. 4 may be rewritten e.g., as:

min Σₘ₌₁^{M}Σₖ₌₁^{K}∥a_{i,k}^{*}x′_{m,k}−a_{i-1,k}^{*}x′_{m,k}∥(eq. 5)

where K denotes the number of basic units, and M denotes the number of replayed samples. A basic unit with smaller k is e.g., at a relative lower layer of computer network (e.g., constraining only the units in the last layer can already achieve good results). x′_{m,k} is the input of kth basic unit and is calculated through forward propagation, except x′_{m,1}=DG_{D}(zₘ^{sample}, φ′_{d}) which is the initial replayed sample x′ₘ generated by data Generator (DG) 206 (before optimizing current task Tᵢ) a_{i,k}^{*} is jointed parameter.

Data Generator (DG) 206: As indicated earlier, DG may have various functions, e.g.:

Data Generator (DG) 206 may compresses the original input data xᵢ 210 to embedding zᵢ 218 using its encoder 212 to reduce the number of dimensions of xᵢ and consequently reduce the mapping space of DPP 204 to reduce the complexity and improve the efficiency of generating the parameters pᵢ 220. The compression may be formulated e.g., by:

zᵢ=DG_{E}(xᵢ,φₑ) (eq. 6)

where DG_{E} is the encoder 212 of DG with parameters φₑ.

Data Generator (DG) 206 may generate the replayed data for previous tasks to deal with forgetting in computer C 202 and DPP 204. DG 206 does not generate both the replay data x′ₘ and their labels y′ₘ (using the computer learned so far), which is typically noisy. DG 206 only generates the data x′ₘ 208 but not the associated labels (which are not needed according to embodiment of the invention), so that labeling errors will not affect the model PPLA.

Each replayed sample x′ₘ 208 is generated by the decoder 216 of DG, referred to as DG_{D}, e.g., as follows:

x′ₘ=DG_{D}(zₘ^{sample}, φ′_{d}) (eq. 7)

where zₘ^{sample} is the m-th sample, e.g., sampled from the multivariate normal distribution, and φ′_{d} is the set of parameters of decoder DG_{D} 216 before optimizing the current task Tᵢ.

DG 206 can be implemented with an auto-encoder, e.g., VAE-like (Variational Auto-Encoder and WAE-like (Wasserstein Auto-Encoder) auto-encoders. One embodiment uses WAE in DG, which allows different examples to stay far away from each other (e.g., having a Euclidean vector distance greater than a predetermined threshold or relatively greater than between other instances), which promotes better reconstruction. For example, if examples or instances are too close to each other creating density, these instances may not be considered representative. Representative instances may be those that differ from others but belong to the same sample or group of instances.

To train DG, embodiments of the invention may use e.g., a mean square error as a reconstruction loss to enable its replay ability of the past data, and add to it a penalized form of the Wasserstein distance between the distribution of embedding zᵢ 218 and multivariate normal distribution to help generate data (e.g., together denoted by ψ_{wae}).

min Σₘ₌₁^{M}∥zₘ^{sample}−DG_{E}x′ₘφₑ∥ (eq. 8)

min Σₘ₌₁^{M}∥DG_{D}(zₘ^{sample},φ_{d})−x′ₘ∥ (eq. 9)

where x′ₘ is the replayed data (see e.g., eq. 4), φₑ and φ_{d} are the encoder's and decoder's parameters of DG for the process of learning new task Tᵢ, respectively, and zₘ^{sample} and M have the same meanings as they are in DPP-C.

Eq. 8 and 9 may constrain the consistency of DG's decoder 216 and encoder 212 over the randomly sampled zₘ^{sample}. Eq. 9 may ensure that DG's decoder 216 can still remember training based on prior task training data. Using eq. 8 and eq. 9, embodiments of the invention maintain the DG's ability to reflect knowledge from the prior task training data. Overall, the final objective function for DG is composed by ψ_{wae}, eq. 8 and eq. 9.

Note, data generator DG 206 may also have a forgetting problem caused by incremental training of new tasks. To avoid data generator DG 206 forgetting its prior task training, embodiments of the invention constrain DG 206, e.g., using loss functions, to overcome its forgetting as shown in FIG. 3.

Reference is made to FIG. 3, which schematically illustrates data structures for training the data generator 206 of FIG. 2 using incremental learning without forgetting, according to some embodiments of the invention. FIG. 3 demonstrates a training pipeline process of data generator (DG). In some embodiments, using the same (only one) DG for all tasks may result in a forgetting problem caused by incremental training of new tasks. To eliminate or reduce the forgetting phenomenon in DG, some embodiments constrain DG using the architecture in FIG. 3, where x′ₘ is replayed data, φₑ and φ_{d} are the encoder's and decoder's parameters of DG in the process of learning the new task Tᵢ, respectively, and zₘ^{sample} and M have the same meanings as they in DPP-C.

The training procedure of the Parameter Propagation in Learning Adaptation (PPLA) may proceed, e.g., as follows:

Algorithm PPLA (Parameter Propagation in learning Adaptation)

```
1: Input: {Tᵢ}ᵢ₌₁^{N} where Tᵢ = (xᵢⱼ, yᵢⱼ) //xᵢⱼ sample;, yᵢⱼ label of sample
2: Init random initialization of g(·), DG (data generator), C
(computer)
//Learning 1^{st} task
4: for n = 0,..., until convergence do
  5: sample minibatch from T₁
  //training DG
  6: Minimize ψ_{wae} and update DS; //ψ_{wae} Wasserstein auto-encoder
  //training DPP (dynamic parameter propagator) add C
  //pₙ an Cₙ are batch of generated parameters and adapted computers
  respectively
  7: Compute pₙ using eq.1 - eq.6
  8: Construct Cₙ using pₙ and φ₀
  9: Minimize ψ_{ce} and update g(·) and C
end for
//Learning sub-sequent tasks
10: for i = 2; i <= N; i++ do
  11: generate replayed samples xₘ′ by DG (data generator)
  12: for n = 0, ..., until convergence do
    13: sample minibatch from Tᵢ;
    14: minimize ψ_{wae} eq.8. & eq.9 and then update DG
    15: compute pₙ using eq.1 - eq.6
    16: construct Cₙ using pₙ and φ₀
    17: minimize ψ_{ce} eq.5 and then update g(·) and C
  18: end for
19: end for
```

While multitasking T₁, . . . , T_{N} allows the proposed model to switch between several problems Tᵢ, learning without forgetting may also be useful during the solving of a single problem. Many tasks can be hierarchically divided into sub-tasks, and the depth of such partition increases with the complexity of the basic task. Achieving a goal in such multilevel environments is a problem. When some mechanisms of active forgetting are introduced, the model can simplify goal achieving by breaking tasks into simpler steps and training a separate combination of neurons for each sub- task. This trick naturally increases the ability of the model to select the correct action.

In addition to reducing forgetting in incremental learning, embodiments of the invention provide other improvements in training machine learning models. In particular, some embodiments of the invention do not increase the parameters or expand the network to learn new tasks. Embodiments of the invention may provide more efficient memory and computational efficiency compared to adding replay data to the training set. Additionally or alternatively, no previous data needs to be stored to enable the system to remember the previously learned models or knowledge.

Evaluation, Results and Comparison: Results of the proposed approach PPLA and compare with state-of-the-art baselines using two image datasets and two text datasets.

Datasets—Two text datasets:
1) DBPedia ontology: a crowd-sourced dataset with 560,000 training samples and 70,000 test samples. Out of the 70,000 test samples, 10,000 were used for validation and 60,000 for testing.
2) THUCNews: a dataset consisting of 65,000 sentences of 10 classes. 50,000/5000/10,000 sentences were randomly selected for training/validation/testing respectively.

Experiment Settings:

Data Preparation: To simulate sequential learning, the same two data processing methods named disjoint and shuffled were used.

Disjoint: This method divides each dataset into several subsets of classes. Each subset is a task. For example, the DBPedia dataset were divided into two tasks (or subsets of classes). The first task consists of digits (classes) {0; 1; 2; 3; 4} and the second task consists of the remaining digits (classes) {5; 6; 7; 8; 9}. The systems learned the two subsets as two tasks in a sequential fashion and regard them together as 10-class classification. In order to consider more tasks in testing, THUCNews, which has all 10 classes, two experiment settings were created of 2 tasks (5 classes per task) and 5 tasks (2 classes per task). For DBPedia, which has 14 classes, three experiment settings were created for 2 tasks (7 classes per task), 3 tasks (5, 5, and 4 classes for the three tasks respectively), and 5 tasks (3, 3, 3, 3, and 2 classes for the 5 tasks respectively).

Shuffled: This method shuffles the input pixels of a text with a fixed random permutation. Two experiment settings were created: 3 tasks and 5 tasks. In both cases, the dataset for the first task was the original dataset. The datasets for the rest of the tasks were constructed through shuffling. Since shuffling of words in a sentence will change the sentence meaning and results in confusion, this experiment was not performed on the text datasets.

Baselines: Results were compared for three state-of-the-art baselines that are representative of the current approaches:
1. EWC (elastic weight consolidation);
2. IMM (incremental moment matching); and
3. GR (generative replay).

Training Details: For fair comparison, embodiments of the invention were tested using the same computer (or classifier) as the baselines. That is, a multilayer perceptron was adopted as the computer/classifier (as the baselines all use this method), which is a 3-layer network (i.e., two basic units with each hidden layer as a unit) followed by a softmax layer. For the inventive approach, the total number of parameters in the computer included both the generated parameters p and the shared parameters φ₀. Due to the differences among different datasets, different settings were adopted for them. All baselines and the inventive approach were compared using the same setting for the same dataset.

Testing used a 3-layer perceptron (with 2 hidden layers) network for DPP and set the size of each hidden layer to 1000. Each network can generate 100 parameters at a time. Several networks may be parallelized in the DPP to generate more parameters when needed. The network parameters were updated using the Adam algorithm with a learning rate of 0.001.

Results and Analysis: results of a comparison between the inventive and baseline systems are shown in Table 1 and Table 2. Tables 1, 2, and 3 below indicate the following:
1. The proposed PPLA technique consistently outperforms the baselines in overcoming forgetting, by a significant margin in most cases.
2. EWC does not perform well for the disjoint setting. GR performs better than EWC, but still worse than the inventive PPLA technique. Adam's results show that forgetting is significant for all datasets and settings.

TABLE 1
Average accuracy over all tasks in a sequence
after the tasks have all been learned.

| | THUCNews | DBPedia | DBPedia |
|---|---|---|---|
| Model | (3 tasks) | (3 tasks) | (4 tasks) |
| EWC | 53.87 | 55.63 | 37.63 |
| IMM | 83.76 | 91.57 | 84.27 |
| PPLA | 86.11 | 95.43 | 88.45 |

Table 1 shows that the PPLA technique has consistently superior accuracy than EWC and IMM techniques based on different datasets with 3 or 4 tasks (5 tasks results are given in Table 2). This improvement is at least partially based on the ability of the PPLA model to reduce the effects of the accuracy deterioration problem. EWC's performance is poor for the disjoint case (a more realistic setting in practice).

TABLE 2
Average accuracy over 5 tasks in a sequence
after the tasks have all been learned.

| | THUCNews | DBPedia |
|---|---|---|
| Model | (5 tasks) | (5 tasks) |
| GR (Generative Replay) | 48.33 | 60.39 |
| IMM | 47.67 | 64.87 |
| PPLA | 53.54 | 71.34 |

Table 2 shows that the PPLA technique has consistently superior accuracy to GR and IMM techniques based on different datasets with 5 tasks.

Ablation Study: understand performance by removing parameters. Table 3 analyses how the system behaves with less and less shared parameters in φ₀ or more and more parameters replaced by the parameters 220 generated by DPP 204. The disjoint DBPedia tasks setting were selected to conduct the experiment as it is more useful and more difficult than other datasets. DBPedia is more useful because it contains many more training samples and test samples than other datasets, such as, THUCNews and the like. DBPedia is more difficult in current context of experiments because it has many classes (14), and complex configuration set of classes per different tasks.

TABLE 3
Average accuracy with different % of parameters in computer's last layer (one basic unit)
being replaced by the parameters generated by DPP. Each score followed by a 95% confidence
interval.

| Model | GR | PPLA | | | | | |
|---|---|---|---|---|---|---|---|
| Accuracy | 86.32 (±2.85) | 0% | 20% | 40% | 60% | 80% | 100% |
| | | 89.68 | 91.32 | 92.91 | 94.57 | 97.23 | 98.08 |
| | | (±0.53) | (±1.22) | (±0.67) | (±0.86) | (±0.44) | (±0.73) |

Table 3 shows accuracy results (averaged in the same way as in Table 1) when a portion of the parameters in only the last layer of the computer is replaced by the parameters generated by DPP 204. The accuracy improves with increased percentages of parameters being replaced. The best accuracy is obtained when 80% of the parameters in the last layer are replaced through DPP, and the accuracy does not further improve with more replaced parameters. This observation indicates that replacing a part of parameters in computer to adapt new input tasks is sufficient. The same conclusion can also be made by replacing the parameters in the first hidden layer of the computer (which has 2 hidden layers). The replacing percentage of the last layer were fixed to 20%, and then the replacing percentages of the first layer were increased. The best accuracy reaches 92.91%(±0.67%) when replacing 40% parameters of the first layer, which gains only 1.87% in accuracy compared with no replacement. This result indicates that it suffices to replace the parameters in the last layer.

Embodiments of the invention propose a novel approach PPLA to reduce or eliminate catastrophic forgetting. The PPLA approach learns to build a model with two sets of parameters. The first set is shared by all tasks learned so far and the second set is dynamically generated to adapt the model (computer) to suit each individual test example. Experimental results show that the proposed approach significantly outperformed existing baseline methods.

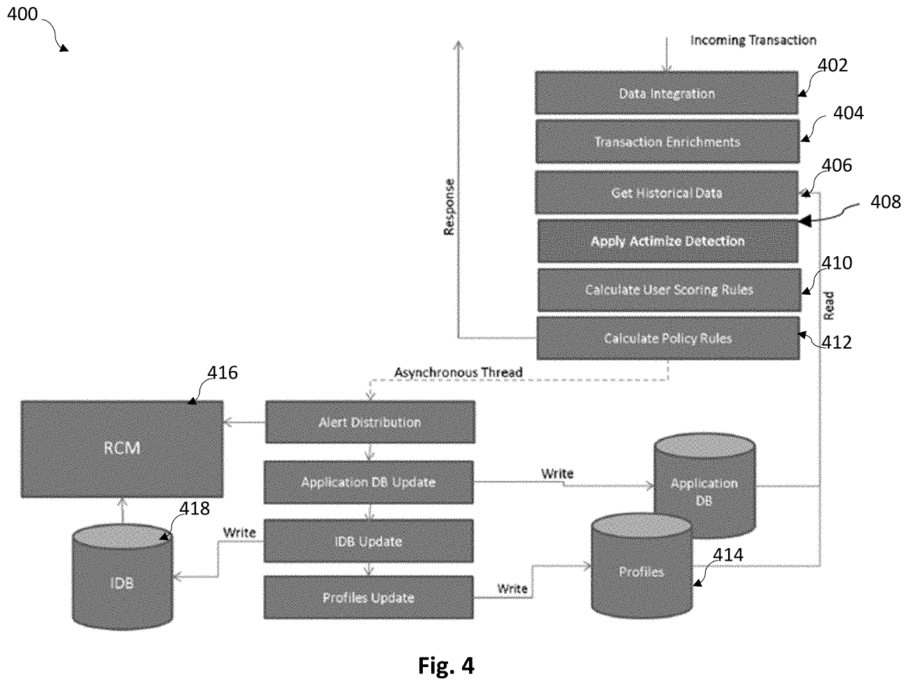

Reference is made to FIG. 4, which schematically illustrates data structures for an example implementation of training using incremental learning without forgetting, according to some embodiments of the invention.

FIG. 4 shows example of where AI detection data structures 408 described according to embodiments of the invention, such as in FIGS. 2 and 3, may reside in a system 400. Data structures 402 may receive processed data from the global system, build superior training dataset and pass it forward into a detection model. Fitted into this system 400, AI detection data structures 408 may not impact the surrounding architecture or the rest of system 400 itself, nor affect the detection and post detection stages of the product.

Data integration 402 receives incoming transactions and initially preprocesses the incoming data. Transaction enrichments 404 may preprocess the transactions. Data integration 402 may preprocess incoming transaction by e.g., data cleaning, filling in missing values, detection outliers, normalization, ETL processes, and transaction enrichments 404 may preprocess by e.g., augmenting (enlarging) the number of fraudulent transactions (e.g., transactions labeled as fraud). The process of getting historical data 406 synchronizes historical data with the new incoming transactions received by data integration 402. AI detection data structures 408 may detect events based on training a machine learning model using incremental learning without forgetting as described according to embodiments of the invention. In an example fraud detection system, each transaction gets its risk score 410. Policy calculation 412 treats the suspicious scores and routes accordingly. Profiles contain aggregated transactions according time period. Profile 414 updates synchronize according to new created/incoming transactions. Risk Control Management (RCM) 416 manages risk score including, e.g., investigation, monitoring, sending alerts, or marking as no risk. Investigation Data Base (IDB) 418 is used to investigate when researching transactional data and policy rules 412 result in an investigation. IDB 418 analyzes historical cases and alert data. Data can be used by the solution or by external applications that can query IDB 418, for example, to produce rule performance reports.

Variables: Analysts can define calculated variables using a comprehensive context such as a current transaction, a history of the main entity associated with the transaction, built-in models results, etc. These variables can be used to create new indicative features. The variables can be exported to the detection log, stored in IDB 418, and exposed to users in user analytics contexts.

Custom Events: Transactions that satisfy certain criteria may indicate occurrences of events that may be interesting for an analyst. The analyst can define events the system identifies and profiles when processing the transaction. This data can be used to create complementary indicative features (e.g., using the custom indicative features mechanism or Structured Model Overlay (SMO)). For example, the analyst can define an event that defined by a transaction of an amount>$100,000. The system may profile aggregations for all transactions that trigger this event (e.g., first time it happened for the transaction party, etc.). For example, the system may aggregate transactions (e.g., sum up numerically) for a specific type of transaction and for a certain period.

Custom Indicative Features: Once custom events are defined, the analyst can use predefined indicative feature templates to enrich built-in model results with new indicative features calculations. Proceeding with the example from the custom events section—The analyst can now create an indicative feature that defines e.g., if it has been more than a year since the customer performed a transaction with amount greater than $100,000, then add 10 points to the overall risk score of the model.

Structured Model Overlay (SMO) is a framework in which the analyst gets all outputs of built-in and custom analytics as input (such as the above) to be used to enhance the detection results with issues and set the risk score of the transaction.

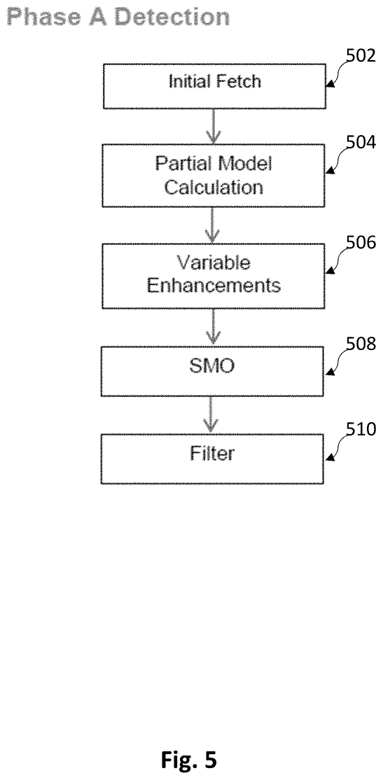

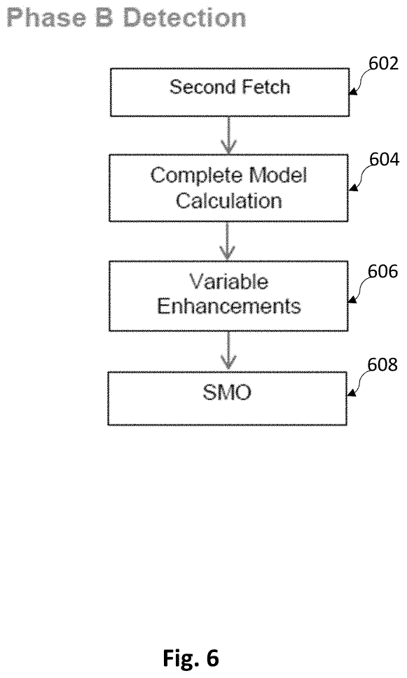

Filter: As described below in reference to FIGS. 5 and 6, analytics logic may be implemented in two phases, e.g., where for efficiency only subset of the transactions goes through the second phase, as determined by a filter.

Detection Log: A detection log may contain transactions enriched with analytics data such as indicative features results and variables. An analyst has the ability to configure which data should be exported to the log and use it for both pre-production and post-production tuning.

Detection Flow: The detection flow for transactions may include multiple steps, data fetch for detection (e.g., detection period sets and profile data for the entity), variable calculations, analytics models including different indicative feature instances, and/or SMO (structured model overlay). The detection process may be triggered for each transaction. However, most of the analytics logic relates to entities rather than transactions. For example, all transactions for the same entity (e.g., party) may trigger detection, whilst the detection logic is based on the party activity in the detection period.

Reference is made to FIGS. 5 and 6, which are flowcharts of respective phases of detecting events using a machine learning model trained by incremental learning without forgetting, according to some embodiments of the invention. To improve performance and efficiency, the detection flow for transactions may be divided into two phases, phase A shown in FIG. 5 and phase B shown in FIG. 6. Analytics logic may be run after phase A to decide whether it is necessary to run phase B. The decision not to proceed to phase B may be due to one or more of the following reasons: the transaction is definitely suspicious or the transaction is definitely not suspicious. If it is not yet clear if the transaction is suspicious, processing continues with phase B detection.

In Phase A Detection shown in FIG. 5, a process or processor may proceed to execute operations 502-510, e.g., as follows.

Initial fetch 502 may fetch the profiles and accumulation period data needed for the detection (e.g., for a card). For example, initial fetch 502 may fetch the card profiles and device profiles and the previous activity by the card set. The data which is fetched may be used for Actimize detection (e.g., 408 of FIG. 4), AAE and Policy Manager.

Partial model Calculation 504 may calculate custom events, performs analytics models, both for internal indicative features and custom indicative features. Partial model calculation 504 may determine an analytics risk score.

Variable Enhancements 506 may run phase A variables.

SMO 508 may be an Intelligence Server (IS) exit point that can be used by analytics to enrich out-of-the-box models (e.g., using internal indicative features and/or custom indicative features). SMO 508 may override the analytics risk score. The final step of the SMO model may be to recommend whether or not to proceed to phase B, although the final decision may additionally or alternatively, be made by the filter 510.

Filter 510 may decide whether or not to perform phase B of the detection process of FIG. 6. Filter 510 may include out-of-the-box and/or custom parts. Filter 510 may be implemented by an AIS exit point.

In Phase B Detection shown in FIG. 6, a process or processor may proceed to execute operations 602-608, e.g., as follows.

Second fetch 602 may retrieve data based on more complex queries than initial fetch 502, for example, multiple payees per transaction.

Complete Model Calculation 604 may perform additional internal indicative features and custom indicative features.

Variable Enhancements 606 may perform more calculations based on newly retrieved sets.

SMO 608 may decide the final score for the transaction. This can be based on the same or additional models as SMO 508.

Other or different operations or orders of operations may be used than shown in FIGS. 5 and 6.

Calculating base activities: Activities are a way to logically group together events that occur in the client's systems, e.g., as follows:
a. Each channel is an activity, for example, a Web activity.
b. Each type of service is an activity, for example, an Internal Transfer activity.
c. Each combination of an activity and a type of service is an activity, for example, a Web Internal Transfer Activity.
d. Activities can span multiple channels and services, for example, the Transfer activity, which is any activity that results in a transfer.
e. Transactions can be associated with multiple activities.

Base Activities: Activities may be divided into multiple base activities. Base activities may represent a specific activity the customer performed and determine which detection models are calculated for a transaction. Each transaction may be mapped to one and only one base activity. A base activity may be calculated for each transaction. The default base activity is usually determined according to the channel and the transaction type, and/or additional fields and calculations.

Calculating Base Activities: The tables in this section provide details of example fields used to calculate the base activity for each combination of solution, channel and transaction type. The base activity of a transaction may be set by combining the channel type and the transaction type as mapped in data integration. The definition of some base activities may also be based on value(s) of additional field(s) and/or calculated indicator(s), as detailed in the tables in this section. For an acquirer, the base activity may be calculated by combining the channel type, the message purpose and additional fields, as detailed in the relevant tables.

### Fraud Detection Application

Financial fraud is an issue with far reaching consequences in various industries including government, corporate sectors, and for ordinary consumers. Increasing dependence on new technologies such as cloud and mobile computing in recent years has compounded the problem. Not surprisingly financial institutions have turned to automated process using numerical and computational methods. Data mining based approaches have been shown to be useful because of their ability to identify small anomalies in large data sets. There are many different types of fraud, as well as a variety of data mining methods, and research is continually being undertaken to find the best approach for each case. Financial fraud events take place frequently and then result in huge financial losses. Consequently, financial fraud causes severe problems for government and business. However, detecting such a fraud has always been challenging. With the rapid development of the e-commerce and e-payment, the problem of online transaction fraud has become increasingly prominent. Compared with traditional areas, online transaction is facing a considerably larger volume of fund transfer. Therefore, banks and financial institutions offer online (incremental) fraud detection systems much value and demand. Fraudulent transactions occur in streaming processes where there is a need to be able to detect anomaly behavior rapidly and instantaneously.

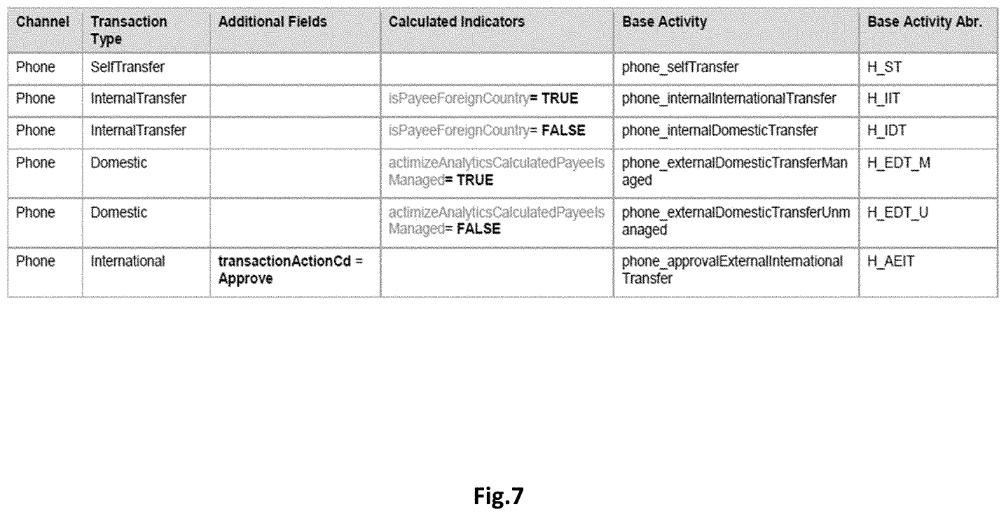

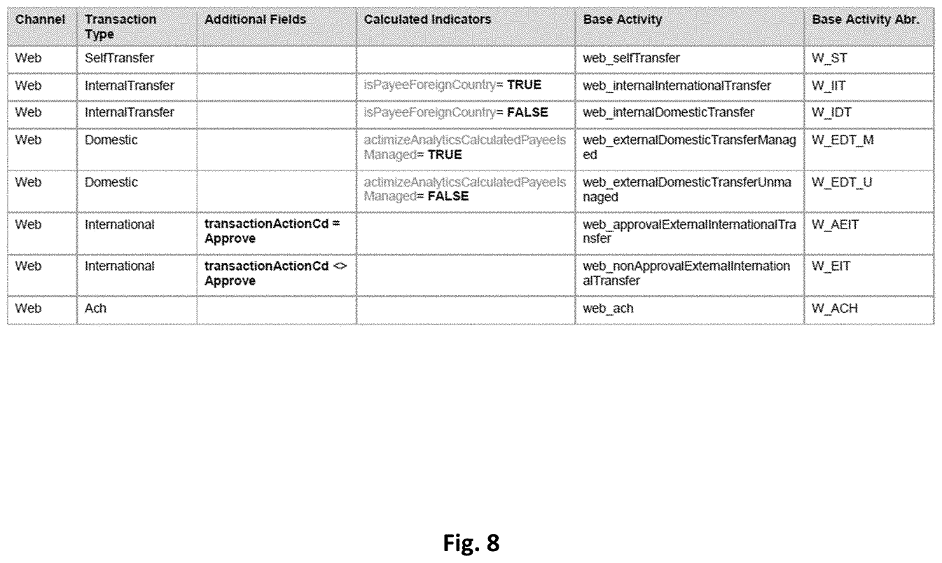

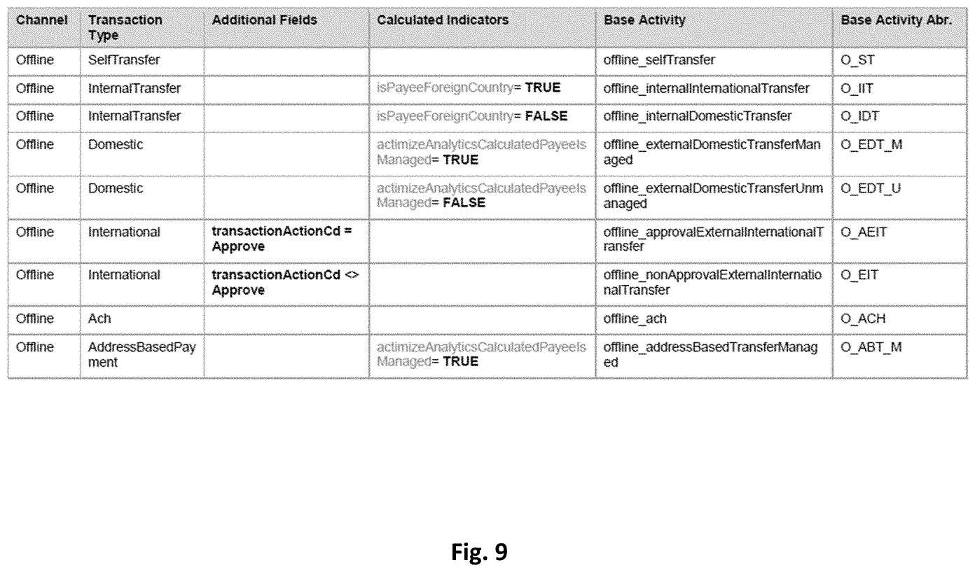

Embodiments of the invention may fetch data (e.g., using data integration 402 of FIG. 4, initial fetch 502 of FIG. 5, and/or second fetch 602 of FIG. 6) over one or more communication channels, including a phone channel fetching example phone data shown in FIG. 7, a Web channel fetching example Web data shown in FIG. 8, and an offline channel fetching example offline data shown in FIG. 9.

Data Pre-processing may include performing one or more of the following operations:
a. Check IFM filtration
b. Determine if the model refers to all or only some of the events, e.g.:
   i. Add/edit payee
   ii. Reject notifications
   iii. Account service events
c. Determine if there are differences at data mapping for different types of events
d. Determine if the versioning is in scope
e. Determine which events and/or versions the Financial Institution (FI) is alerting/blocking

Fraud review may include determining one or more of the following factors which may impact the quality of the fraudulent dataset, e.g.:
a. Partial data—the provided fraud report may be based on one system, but the client is using one or more other non-analyzed systems to monitor fraud data.
b. The only alerted transactions were included with no missing fraud—that will impact the ability of the tuned model to learn from the current model's weakness.
c. Incorrect fraud tagging performed by fraud investigators.
d. Purpose of Fraud Enrichment:
   i. Increase the volume of the fraudulent dataset—more samples from which to learn.
   ii. Lower the risk of incorrectly categorizing fraudulent transactions as non-fraudulent, and vice versa.
   iii. Used as a tool to review the quality of the fraudulent dataset, e.g., if the number of enriched transactions is relatively high, it is suspicious.
e. Basic Fraud Enrichment criteria:
   i. Same Party, Same Payee.
   ii. Same Device, Same Payee, other parties.
      If the fraud review is indeterminate, the transaction may be excluded from both fraudulent and non-fraudulent datasets.

Feature Selection Considerations may review data mapping and data validation documents and/or exclude data elements that are associated with incorrect mapping or with known data issues, for example, as follows:
1. Exclude all keys fields such as party-Key.
2. Exclude all scrambled fields. If a meaningful field was detected to be scrambled, update PS/Product team so scrambling will be removed before the next tuning.
3. Exclude Policy Manager (PM) Operational fields such as ‘actimizeOperationsChallengeRecommendedInd’—those are not available in real time.
4. Review data elements which populate only for a small fraction of the population—determine if the feature/value is truly ‘rare’ or if it is caused by a data issue. Additionally or alternatively feature selection may exclude ‘suspicious’ features (e.g., lift>1) that are populated by less than a threshold number (e.g., 50) fraudulent transactions.
5. Exclude features coming from an external scoring systems and/or from an external list such as ‘External Score 1’ or ‘External High Focus Payee’. It may be safer to avoid a dependency on external systems which may change in the future. Those type of features can be used in PM rules.
6. Exclude features with a very specific ‘short life’ values such as specific geographical regions, specific IP addresses or specific amount values. Fraudsters are smart and quick to respond. For example, if a model trained on narrow features that represent only very specific values, then the model would not be able to detect such activities that include different values for these narrow types or ranges of values. That means, the model would not be able to detect a fraudster who knew this and if his activity contain these values/features.
7. Calculate the time difference between different date fields such as last password change date and transaction's date.
8. Feature engineering—preferably or only use transactional raw data when there is not a technical way to leverage engineered feature which are based on calculation derived from more than one transactional raw.

Other or different system preferences, features, and applications may be used.

Learning without forgetting may refer to a reduction in forgetting (retaining more prior training than if no retention was trained) that allows some degree of forgetting, may refer to a maximum threshold of forgetting (e.g., incorrectly predicting less than 25%, 10%, etc. of old tasks) or minimum threshold of retention (e.g., correctly predicting at least 50%, 80%, etc. of old tasks), and/or may refer to training new tasks based on information (training data) from old tasks.

Model parameters may refer to weights of a neural network, hyper-parameters such as an activation function, or more generally to any other model parameters, or other explicit and implicit parameters.

Embodiments of the invention may be used to train models for various applications, such as, security, image event recognition, computer vision, virtual or augmented reality, speech recognition, text understanding, fraud detection, or other applications of deep learning. In the application of facial recognition, a device may use the model to efficiently perform facial recognition to trigger the device to unlock itself or a physical door when a match is detected. In the application of security, a security camera system may use the model to efficiently detect a security breach and sound an alarm or other security measure. In the application of autonomous driving, a vehicle computer may use the model to control driving operations, e.g., to steer away to avoid a detected object. In the application of fraud detection, an alarm system may use the model to detect, report and take action (e.g., send alarms) when fraud is detected.

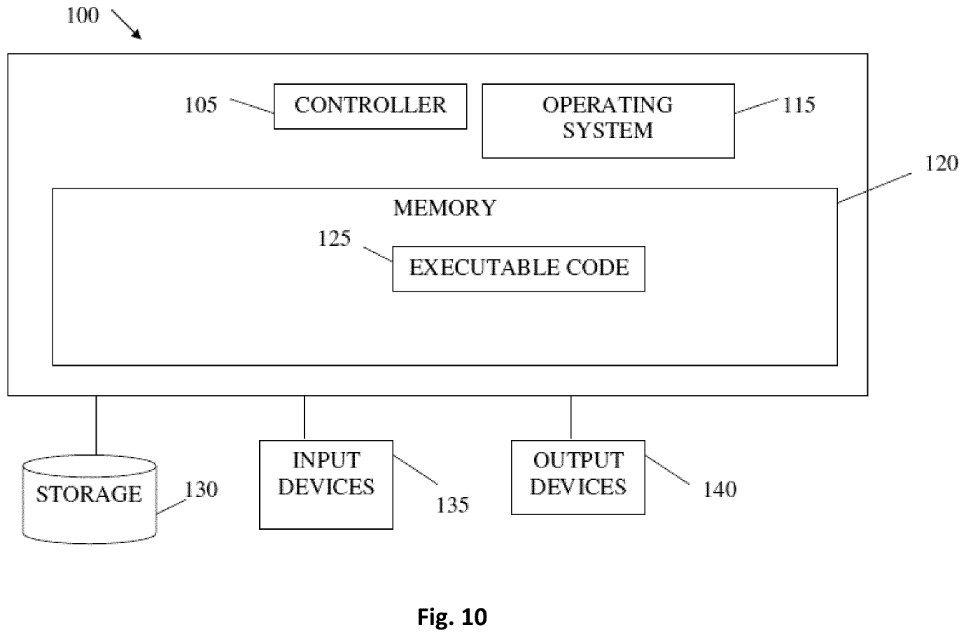

Reference is made to FIG. 10, which schematically illustrates an exemplary system for training a machine learning model using incremental learning without forgetting that may be used with embodiments of the present invention. Computing device 100 may include a controller or computer processor 105 that may be, for example, a central processing unit processor (CPU), a chip or any suitable computing device, an operating system 115, a memory 120, a storage 130, input devices 135 and output devices 140 such as a computer display or monitor displaying for example a computer desktop system. Each data structure, programming code and/or equipment discussed herein may be or include, or may be executed by, a computing device such as included in FIG. 10, although various units among these may be combined into one computing device.

Operating system 115 may be or may include code to perform tasks involving coordination, scheduling, arbitration, or managing operation of computing device 100, for example, scheduling execution of programs. Memory 120 may be or may include, for example, a Random Access Memory (RAM), a read only memory (ROM), a Flash memory, a volatile or non-volatile memory, or other suitable memory units or storage units. Memory 120 may be or may include a plurality of different memory units. Memory 120 may store for example, instructions (e.g. code 125) to carry out a method as disclosed herein, and/or data such as low-level action data, output data, etc.

Executable code 125 may be any application, program, process, task or script. Executable code 125 may be executed by controller 105 possibly under control of operating system 115. For example, executable code 125 may be one or more applications performing methods as disclosed herein. In some embodiments, more than one computing device 100 or components of device 100 may be used. One or more processor(s) 105 may be configured to carry out embodiments of the present invention by for example executing software or code. Storage 130 may be or may include, for example, a hard disk drive, a floppy disk drive, a Compact Disk (CD) drive, a universal serial bus (USB) device or other suitable removable and/or fixed storage unit. Data described herein may be stored in a storage 130 and may be loaded from storage 130 into a memory 120 where it may be processed by controller 105.

Input devices 135 may be or may include a mouse, a keyboard, a touch screen or pad or any suitable input device or combination of devices. Output devices 140 may include one or more displays, speakers and/or any other suitable output devices or combination of output devices. Any applicable input/output (I/O) devices may be connected to computing device 100, for example, a wired or wireless network interface card (NIC), a modem, printer, a universal serial bus (USB) device or external hard drive may be included in input devices 135 and/or output devices 140.

Embodiments of the invention may include one or more article(s) (e.g. memory 120 or storage 130) such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein.

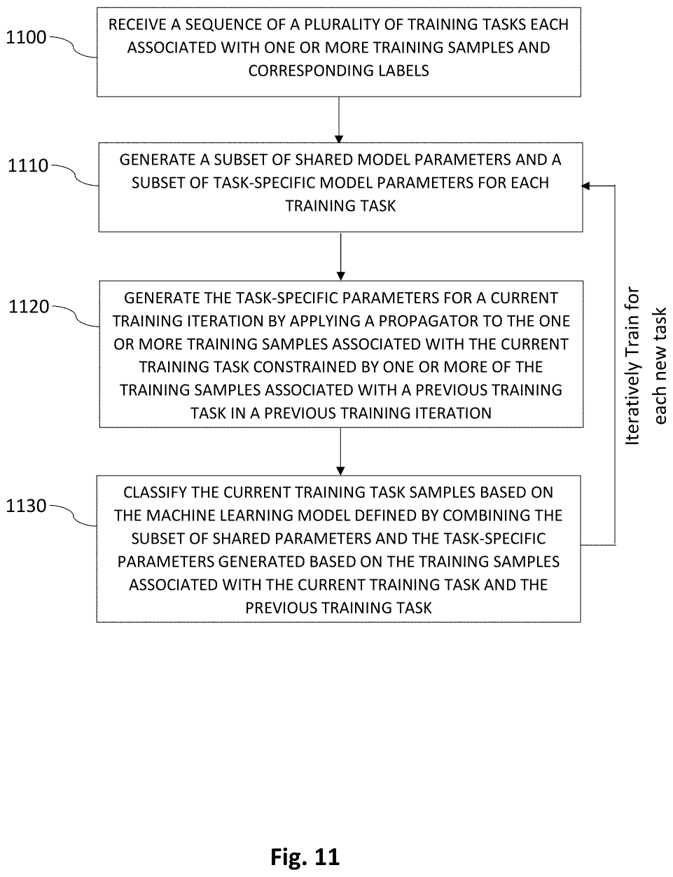

Reference is made to FIG. 11, which is a flowchart of a method for training a machine learning model using incremental learning without forgetting, according to some embodiments of the invention. Operations described in reference to FIGS. 11 may be executed using devices described in reference to FIG. 10 e.g. device 100 using controller 105.

In operation 1100, a processor (e.g., controller 105 of FIG. 1) may receive a sequence of a plurality of training tasks, wherein each training task is associated with one or more training samples and corresponding labels respectively associated with the one or more training samples.

In operation 1110, a processor (e.g., controller 105 of FIG. 1) may generate a subset of shared model parameters that are common to the plurality of training tasks and a subset of task-specific model parameters for each training task that are not common to the plurality of training tasks.

A process or processor may train the machine learning model in a sequence of a plurality of sequential training iterations respectively associated with the sequence of a plurality of training tasks. In each of the plurality of sequential training iterations the machine learning model is trained by iterating over operations 1120-1130.

In operation 1120, a processor (e.g., controller 105 of FIG. 1) may generate the task-specific parameters for the current training iteration by applying a propagator to the one or more training samples associated with the current training task. The training of the model for the current training task may be constrained by one or more of the training samples associated with a previous training task in a previous training iteration. The model may be constrained to reduce minimize variations of one or more layer outputs of the model caused by changes in the subset of shared parameters and the propagator resulting from the current training iteration by using the one or more training samples associated with the previous training task. The propagator for the current training task may be generated based on the one or more of the training samples associated with the previous training task but not the corresponding labels respectively associated therewith. In some embodiments, the propagator may not be applied to the one or more training samples associated with the previous training task to generate the task-specific parameters for the current training task. The one or more of the training samples associated with the previous training task may be generated based on an aggregated distribution of a plurality of the training samples to which the propagator was applied in the previous training iteration.

In operation 1130, a processor (e.g., controller 105 of FIG. 1) may classify the one or more samples associated with the current training task based on the machine learning model defined by combining the subset of shared parameters and the task-specific parameters generated based on the training samples associated with the current training task and the previous training task.

The subset of shared model parameters may be modified when training all of the plurality of training tasks and the subset of task-specific parameters are modified only when training the specific associated task but not the other non-specifically associated tasks. The task-specific parameters for the current training iteration may be generated based on a compressed encoding of the one or more training samples associated with the current training task and a non-compressed version of the one or more training samples associated with the previous training task. The compressed encoding may be generated by an encoder trained by adding a mean square error reconstruction loss of the one or more training samples associated with the previous training task to a penalized form of a Wasserstein distance between the distribution of the compressed encoding and a multivariate normal distribution of an embedded low dimensional space.

A process or processor may iteratively repeat operations 1110-1130 for each new task (e.g., setting the current task to the previous task and the new task to the current task).

These operations may be executed in a different order, some operations may be skipped or combined, and/or other operations may be added.

Embodiments of the invention may improve the technologies of computer automation, machine learning, computer bots, big data analysis, and computer use and automation analysis by using specific algorithms to analyze large pools of data, a task which is impossible, in a practical sense, for a person to carry out. Embodiments may enable more effectively, quickly and cheaply identifying automation opportunities, and finding longer routines to automate combined.

One skilled in the art will realize the invention may be embodied in other specific forms without departing from the spirit or essential characteristics thereof. The embodiments described herein are therefore to be considered in all respects illustrative rather than limiting. In detailed description, numerous specific details are set forth in order to provide an understanding of the invention. However, it will be understood by those skilled in the art that the invention can be practiced without these specific details. In other instances, well-known methods, procedures, and components, modules, units and/or circuits have not been described in detail so as not to obscure the invention.

Embodiments may include different combinations of features noted in the described embodiments, and features or elements described with respect to one embodiment or flowchart can be combined with or used with features or elements described with respect to other embodiments.

Although embodiments of the invention are not limited in this regard, discussions utilizing terms such as, for example, “processing,” “computing,” “calculating,” “determining,” “establishing”, “analyzing”, “checking”, or the like, can refer to operation(s) and/or process(es) of a computer, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that can store instructions to perform operations and/or processes.

The term set when used herein can include one or more items. Unless explicitly stated, the method embodiments described herein are not constrained to a particular order or sequence. Additionally, some of the described method embodiments or elements thereof can occur or be performed simultaneously, at the same point in time, or concurrently.

1. A method for training a machine learning model using incremental learning without forgetting, the method comprising, using a computer processor:
receiving a sequence of a plurality of training tasks, wherein each training task is associated with one or more training samples and corresponding labels respectively associated with the one or more training samples;
generating a subset of shared model parameters that are common to the plurality of training tasks and a subset of task-specific model parameters for each training task that are not common to the plurality of training tasks;
training the machine learning model in a sequence of a plurality of sequential training iterations respectively associated with the sequence of a plurality of training tasks, wherein in each of the plurality of sequential training iterations the machine learning model is trained by:
generating the task-specific parameters for the current training iteration by applying a propagator to the one or more training samples associated with the current training task, wherein the training of the model for the current training task is constrained by one or more of the training samples associated with a previous training task in a previous training iteration; and
classifying the one or more samples associated with the current training task based on the machine learning model defined by combining the subset of shared parameters and the task-specific parameters generated based on the training samples associated with the current training task and the previous training task.

2. The method of claim 1, wherein the model is constrained to reduce minimize variations of one or more layer outputs of the model caused by changes in the subset of shared parameters and the propagator resulting from the current training iteration by using the one or more training samples associated with the previous training task.

3. The method of claim 1, wherein the propagator for the current training task is generated based on the one or more of the training samples associated with the previous training task but not the corresponding labels respectively associated therewith.

4. The method of claim 1, wherein the propagator is not applied to the one or more training samples associated with the previous training task to generate the task-specific parameters for the current training task.

5. The method of claim 1, wherein the subset of shared model parameters are modified when training all of the plurality of training tasks and the subset of task-specific parameters are modified only when training the specific associated task but not the other non-specifically associated tasks.

6. The method of claim 1, wherein the task-specific parameters for the current training iteration are generated based on a compressed encoding of the one or more training samples associated with the current training task and a non-compressed version of the one or more training samples associated with the previous training task.

7. The method of claim 1, wherein the compressed encoding is generated by an encoder trained by adding a mean square error reconstruction loss of the one or more training samples associated with the previous training task to a penalized form of a Wasserstein distance between the distribution of the compressed encoding and a multivariate normal distribution of an embedded low dimensional space.

8. The method of claim 1, wherein the one or more of the training samples associated with the previous training task are generated based on an aggregated distribution of a plurality of the training samples to which the propagator was applied in the previous training iteration.

9. The method of claim 1, wherein the classification model is a neural network (NN) selected from the group consisting of: convolutional neural network (CNN), recurrent neural network (RNN) and multilayer perceptron (MLP).

10. A system for training a machine learning model using incremental learning without forgetting, the system comprising:
one or more memories configured to store a sequence of a plurality of training tasks and one or more training samples and corresponding labels respectively associated with each of the plurality of training tasks; and
one or more processors configured to:
generate a subset of shared model parameters that are common to the plurality of training tasks and a subset of task-specific model parameters for each training task that are not common to the plurality of training tasks, and
train the machine learning model in a sequence of a plurality of sequential training iterations respectively associated with the sequence of a plurality of training tasks, wherein in each of the plurality of sequential training iterations the machine learning model is trained by:
generating the task-specific parameters for the current training iteration by applying a propagator to the one or more training samples associated with the current training task, wherein the training of the model for the current training task is constrained by one or more of the training samples associated with a previous training task in a previous training iteration, and
classifying the one or more samples associated with the current training task based on the machine learning model defined by combining the subset of shared parameters and the task-specific parameters generated based on the training samples associated with the current training task and the previous training task.

11. The system of claim 1, wherein the one or more processors configured to constrain the model to reduce variations of one or more layer outputs of the model caused by changes in the subset of shared parameters and the propagator resulting from the current training iteration by using the one or more training samples associated with the previous training task.

12. The system of claim 1, wherein the one or more processors configured to generate the propagator for the current training task based on the one or more of the training samples associated with the previous training task but not the corresponding labels respectively associated therewith.

13. The system of claim 1, wherein the one or more processors configured not to apply the propagator to the one or more training samples associated with the previous training task to generate the task-specific parameters for the current training task.

14. The system of claim 1, wherein the one or more processors configured to modify the subset of shared model parameters when training all of the plurality of training tasks and modify the subset of task-specific parameters only when training the specific associated task but not the other non-specifically associated tasks.

15. The system of claim 1, wherein the one or more processors configured to generate the task-specific parameters for the current training iteration based on a compressed encoding of the one or more training samples associated with the current training task and a non-compressed version of the one or more training samples associated with the previous training task.

16. The system of claim 1, wherein the one or more processors configured to generate the compressed encoding by an encoder trained by adding a mean square error reconstruction loss of the one or more training samples associated with the previous training task to a penalized form of a Wasserstein distance between the distribution of the compressed encoding and a multivariate normal distribution of an embedded low dimensional space.

17. The system of claim 1, wherein the one or more processors configured to generate the one or more of the training samples associated with the previous training task based on an aggregated distribution of a plurality of the training samples to which the propagator was applied in the previous training iteration.

18. The method of claim 1, wherein the classification model is a neural network (NN) selected from the group consisting of: convolutional neural network (CNN), recurrent neural network (RNN) and multilayer perceptron (MLP).

19. A non-transitory computer-readable medium comprising instructions which, when implemented in one or more processors in a computing device, cause the one or more processors to:
receive a sequence of a plurality of training tasks, wherein each training task is associated with one or more training samples and corresponding labels respectively associated with the one or more training samples;
generate a subset of shared model parameters that are common to the plurality of training tasks and a subset of task-specific model parameters for each training task that are not common to the plurality of training tasks;
train the machine learning model in a sequence of a plurality of sequential training iterations respectively associated with the sequence of a plurality of training tasks, wherein in each of the plurality of sequential training iterations the machine learning model is trained by:
generating the task-specific parameters for the current training iteration by applying a propagator to the one or more training samples associated with the current training task, wherein the training of the model for the current training task is constrained by one or more of the training samples associated with a previous training task in a previous training iteration; and
classifying the one or more samples associated with the current training task based on the machine learning model defined by combining the subset of shared parameters and the task-specific parameters generated based on the training samples associated with the current training task and the previous training task.

20. The non-transitory computer-readable medium of claim 19, comprising instructions which, when implemented in the one or more processors in the computing device, further cause the one or more processors to generate the one or more of the training samples associated with the previous training task based on an aggregated distribution of a plurality of the training samples to which the propagator was applied in the previous training iteration.
